(19) United States
(12) Patent Application Publication
(10) Pub. No.: US 2016/0127721 A1
(43) Pub. Date: May 5, 2016

(54) Graphical Display Device

(71) Applicants: KABUSHIKI KAISHA TOSHIBA, Tokyo (JP); Toshiba Lifestyle Products & Services Corporation, Tokyo (JP)

(72) Inventors: Masaaki Ikuta, Hamura Tokyo (JP); Kyosuke Takahashi, Higashiyamato Tokyo (JP)

(21) Appl. No.: 14/878,752

(22) Filed: Oct. 8, 2015

Related U.S. Application Data
(60) Provisional application No. 62/073,480, filed on Oct. 31, 2014.

(51) Int. Cl. H04N 13/04; G02B 27/28

(52) U.S. Cl. CPC H04N 13/0434; G02B 27/288; H04N 13/0468; H04N 13/0497; H04N 13/0486

(57) ABSTRACT

According to one embodiment, a graphical display device includes a display that displays a picture including a first image that is a first circularly polarized light component and a second image that is a second circularly polarized light component opposite in polarization to the first circularly polarized light component, reflecting member that displays the second image, an setting module that set an observation position, a graphics processor that outputs the first image and the second image corresponding to the observation position to the display, and a polarizing filter transmitting light having the first circularly polarized light component.

### CROSS-REFERENCE TO RELATED APPLICATIONS

This application claims the benefit of U.S. Provisional Application No. 62/073,480, filed Oct. 31, 2014, the entire contents of which are incorporated herein by reference.

### FIELD

Embodiments described herein relate generally to a graphical display device.

### BACKGROUND

A liquid crystal display device input the first and second image signals displays the first image signal in odd-numbered display lines and the second image signal in even-numbered display lines. The display screen of the liquid crystal display device comprises polarized light elements in odd-numbered display lines and even-numbered display lines. The direction of polarization of the odd-numbered display lines is different from that of the even-numbered display lines. (The directions of polarization are the first and second directions of polarization. When light is reflected by a mirror, the first direction of polarization turns to the second direction of polarization, and the second direction of polarization turns to the first direction of polarization.)

The liquid crystal display device comprises a left mirror and a right mirror on both sides of the display surface of the device. The left mirror and the right mirror stand from the display surface.

The viewer looks at a display screen and a mirror screen through a polarizing filter which transmits light having one of the first and second directions of polarization. For example, in case of a polarizing filter which transits light having the first direction of polarization, the viewer can see the first image in the odd-numbered display lines on the display screen and see the second image in the even-numbered display lines on the mirror screen through the filter. Thus, the viewer can view an image which is approximately twice wider than the display screen in terms of the area in the crosswise direction.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing a configuration of a graphical display device according to a first embodiment;

FIG. 2 shows an example of an image process of a graphics processor;

FIG. 3 is a perspective view of the graphical display device;

FIG. 4 shows observation areas of an expansion display module according to the first embodiment;

FIG. 5 is a schematic view showing an example of the relationship between an expansion display image and an observation position in an observation area of a front side of the expansion display module;

FIG. 6 is a schematic view showing an example of the relationship between an expansion display image and an observation position in an observation area of each lateral portion of the expansion display module;

FIG. 7 is a schematic view showing an example of an expansion display image when observation is performed in a central position of the observation area of the front side of the expansion display module;

FIG. 8 is a schematic view showing an example of an expansion display image when observation is performed in a position other than the central position of the observation area of the front side of the expansion display module;

FIG. 9 shows an image process of the graphics processor in case of FIG. 8;

FIG. 10 is a schematic view showing an example of an expansion display image when observation is performed in an observation area of an outer side of a first semi-silvered mirror;

FIG. 11 shows an image process of the graphics processor in case of FIG. 10;

FIG. 12 is a schematic view showing an example of an expansion display image when observation is performed in an observation area of an outer side of a second semi-silvered mirror;

FIG. 13 shows an image process of the graphics processor in case of FIG. 12;

FIG. 14 is a flowchart for automatically processing an expansion display image by a system controller;

FIG. 15 is a perspective view of the graphical display device of a first modification example of the first embodiment;

FIG. 16 is a perspective view of the graphical display device of a second modification example of the first embodiment;

FIG. 17 is a perspective view of the graphical display device of a third modification example of the first embodiment;

FIG. 18 is a perspective view of a graphical display device according to a second embodiment;

FIG. 19 shows an observation area of the graphical display device according to the second embodiment;

FIG. 20 is a perspective view of the graphical display device of a modification example of the second embodiment;

FIG. 21 shows observation areas of the graphical display device according to the second embodiment;

FIG. 22 is a perspective view of the graphical display device of a modification example of the second embodiment;

FIG. 23 shows observation areas of the graphical display device according to the second embodiment; and

FIG. 24 is a perspective view of a graphical display device of a modification example of a third embodiment.

### DETAILED DESCRIPTION

Various embodiments will be described hereinafter with reference to the accompanying drawings.

In general, according to one embodiment, a graphical display device comprises: a display module configured to display a picture comprising a first image which is a first circularly polarized light component and a second image which is a second circularly polarized light component opposite in polarization to the first circularly polarized light component; at least one reflecting member configured to display the second image included in the picture displayed in the display module as a mirror image; an observation position setting module configured to set an observation position indicating a position in which the display module and the reflecting member are observed; a graphics processor configured to generate the first image and the second image by dividing an input picture which is input in a manner corresponding to the observation position set by the observation position setting module, and output the first image and the second image as the picture to the display module; and a polarizing filter which is provided between the observation position and members including the display module and the reflecting member, the polarizing filter transmitting light having the first circularly polarized light component.

Embodiments will be described hereinafter with reference to the accompanying drawings.

### First Embodiment

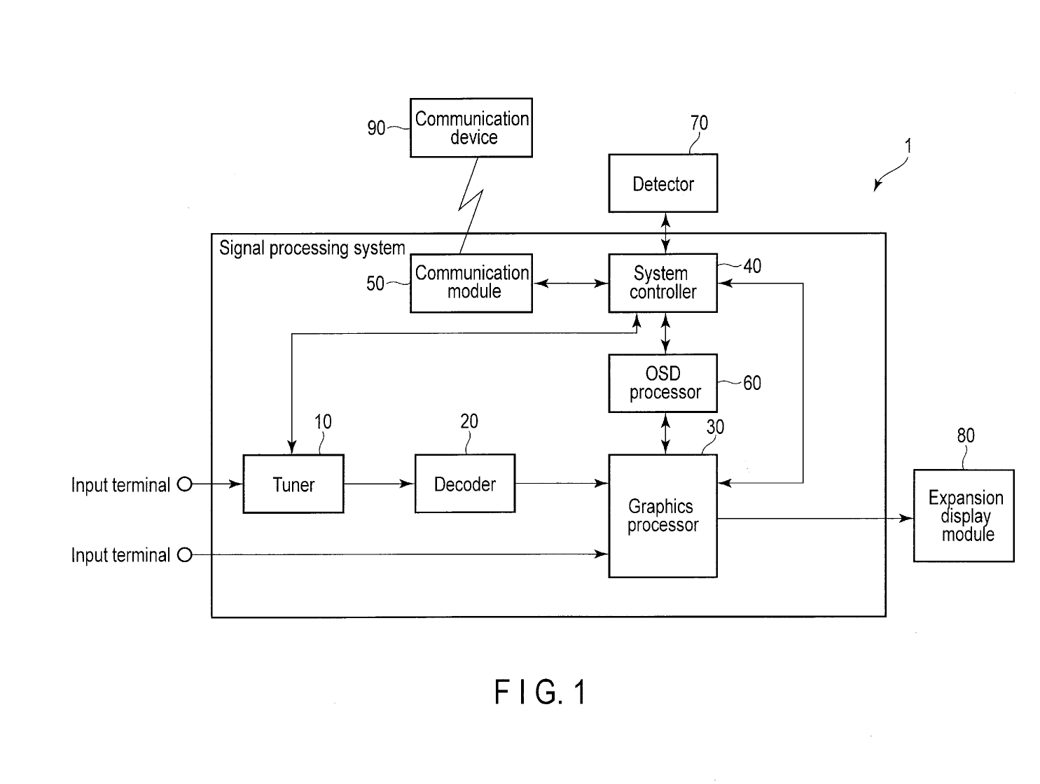

FIG. 1 is a block diagram showing a configuration of a graphical display device 1 according to a first embodiment.

In the first embodiment, the graphical display device 1 comprises a tuner 10, a decoder 20, a graphics processor 30, a system controller 40, a communication module 50, an on-screen-display (OSD) processor 60, a detector 70 and an expansion display module 80. Each of these elements provided in the graphical processing display device 1 is assumed to be realized as a hardware circuit. The functions of the graphics processor 30, the system controller 40 and the OSD processor 60 may be software processes by an application processor. The graphical display device 1 can communicate with a communication device 90.

In a case where the graphical display device 1 displays a program which is sent via a broadcast wave, the graphical display device 1 inputs the broadcast wave to the tuner 10, obtains the program on the channel set by the tuner 10 and outputs the obtained program through the decoder 20 to the graphics processor 30.

In a case where picture/image data is input to the graphical display device 1 from an external device, the graphical display device 1 directly inputs the picture/image data from an input terminal, such as an HDMI, a video input terminal or a USE, to the graphics processor 30. In the explanation below, the terms “image data”, “picture data”, “image signal” and “picture signal” can be replaced by each other.

The tuner 10 selects a channel and a program from the input signal sent as the broadcast wave input from an input terminal in accordance with a control signal and demodulates the selected channel and program. The tuner 10 transmits the demodulated signal to the decoder 20.

The decoder 20 decodes the input demodulated signal and outputs it to the graphics processor 30.

The graphics processor 30 obtains image data (an image) from an input image which is sent from the decoder 20 or the outside. The graphics processor 30 generates an expansion display image to be displayed in the expansion display module 80 from the image data.

In the present embodiment, the graphics processor 30 divides an image into a first expansion image to be displayed in a first expansion display area, a second expansion image to be displayed in a second expansion display area and a central image to be displayed on the central screen. This dividing process is arbitrarily performed by the communication device 90, etc., and is automatically performed by the system controller 40. The graphics processor 30 sets a parallax value for each of the first expansion image, the second expansion image and the central image. The graphics processor 30 reallocates the divided central image, first expansion image and second expansion image and generates expansion display image data (an expansion display image). The graphics processor 30 outputs the generated expansion display image to the expansion display module 80. The graphics processor 30 may be configured such that a parallax image is input from an external device.

In accordance with the setting and an arbitrary signal by the communication device 90, etc., the graphics processor 30 is configured to obtain picture/image data which is input from the tuner 10 and an external device, adjust the divisional ratio of the image and generate an image (expansion display image) having a format suitable for the expansion display module 80. The graphics processor 30 is configured to combine GUI data which is input from the OSD processor 60 and an expansion display image.

The graphics processor 30 obtains an image from the decoder 20 or an input image and generates an image for displaying a three-dimensional image in accordance with the preset setting. For example, the graphics processor 30 is configured to convert a two-dimensional image into a three-dimensional image and generate an image having a necessary parallax value.

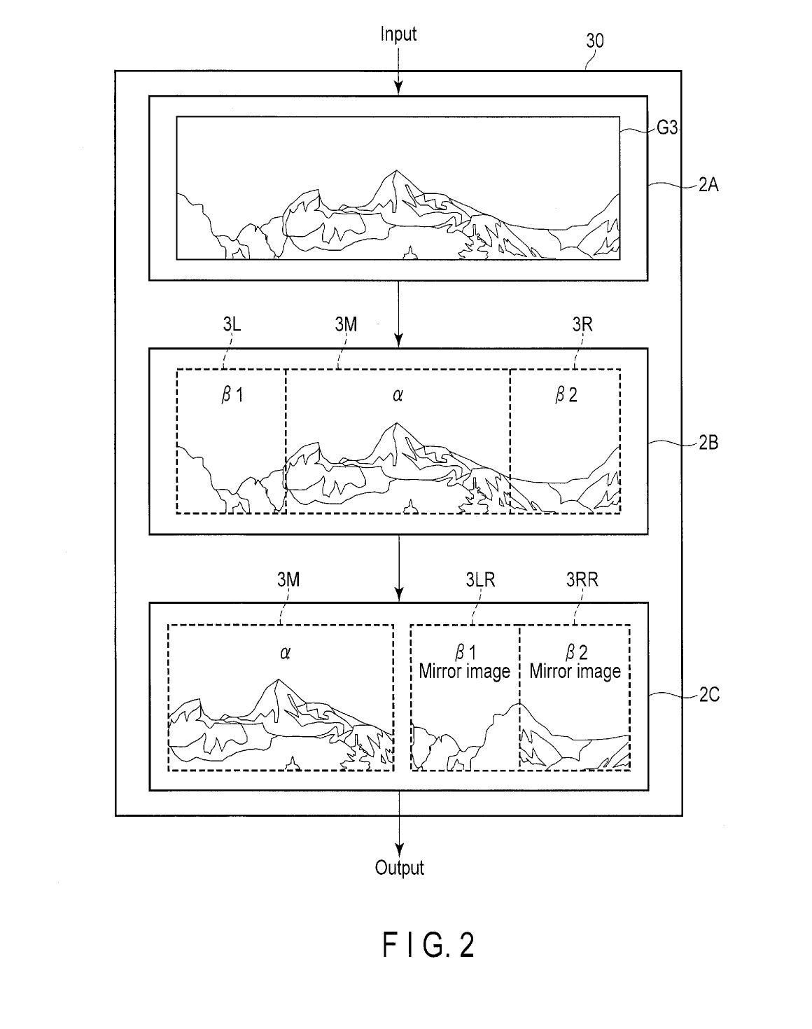

FIG. 2 shows an example of an image process of the graphics processor 30.

Now, this specification explains an example of the image process of the graphics processor 30 with reference to FIG. 2.

In image processing step 2A, the graphics processor 30 obtains image data (an input image) G3 of a frame of video data which is input from the decoder 20 or the outside. The input image G3 is the whole image (expansion display image) displayed in the expansion display module 80. For example, the input image G3 is a rectangular panoramic image having a long axis and a short axis. In a longitudinal shifting process (explained later), the graphics processor 30 processes the input image G3 such that the same piece of the input image G3 is repeatedly displayed on both longitudinal end portions. Specifically, when shifting the image (picture) position, the graphics processor 30 attaches, to the side opposite to the shifting direction, the image (picture) of the portion which has been gone from the display area on the shifting direction side. Thus, the same piece of the input image G3 is connected to both longitudinal end portions of the input image G3 in a pseudo (virtual) manner.

In image processing step 2B, the graphics processor 30 divides the input image G3 and generates first expansion image data (first expansion image) 3L which is displayed in the first expansion display area, second expansion image data (second expansion image) 3R which is displayed in the second expansion display area and central image data 3M which is displayed in the central screen (central display area). For example, the graphics processor 30 divides the input image G3 in the ratio of the display areas of the central screen, the first display area and the second display area. For example, when the ratio of the central screen to the first display area to the second display area is 2:1:1, the graphics processor 30 divides the input image G3 in the ratio of 2:1:1. The graphics processor 30 is also configured to divide the input image G3 in an arbitrary ratio in accordance with the user setting, an instruction by the system controller 40, etc.

In image processing step 2C, the graphics processor 30 inverts each of the first expansion image data (first expansion image) 3L and the second expansion image data (second expansion image) 3R and generates each of first inversion image data (a first inversion image) 3LR and second inversion image data (a second inversion image) 3RR. The first expansion image 3L is inverted to generate the first inversion image 3LR. The second expansion image 3L is inverted to generate the second inversion image 3RR. The graphics processor 30 converts the format of the generated central image, first inversion image and second inversion image into a format which is appropriately displayed in the expansion display module 80.

Further, in image processing step 2C, the graphics processor 30 supplies the generated expansion image data to pixel circuits arranged in a two-dimensional pattern in the expansion display module 80. At this time, for example, the graphics processor 30 supplies the horizontal line image data items of the central image data (first image) 3M to the pixel circuits of the respective odd-numbered display lines of the expansion display module 80 and supplies the horizontal line image data items of the first inversion image data 3LR and the second inversion image data 3RR to the pixel circuits of the respective even-numbered display lines of the expansion display module 80. The first inversion image data 3LR and the second inversion image 3RR which are supplied to the image circuits of the even-numbered display lines may be integrated as an inversion image (second image).

In the above manner, the graphics processor 30 generates the expansion display image by the image process.

Returning to FIG. 1, the system controller (observation position setting module) 40 controls the operation of each module of the graphical display device 1. Specifically, the system controller 40 controls the tuner 10, the decoder 20, the graphics processor 30, the communication module 50, the OSD processor 60, the detector 70, the expansion display module 80, etc. The system controller 40 is configured to output signals of various control commands corresponding to input signals (operation signals) which are transmitted by the communication device 90 and received by the communication module 50 (explained later). For example, the system controller 40 executes the specification and instruction regarding an image process to the graphics processor 30, the determination regarding an operation instruction from the user through the communication device 90 and the instruction to a relevant module, the specification regarding the selection channel to the tuner 10, the instruction regarding the type or parameter of the GUI display data generated in the OSD processor 60, etc.

In the present embodiment, the system controller (observation position setting module) 40 receives a signal from the detector 70 and the communication device 90 (explained later), arbitrarily and automatically sets the target, for example, the observer (viewer) and the position of the observer (observation position) and outputs an instruction signal of an image process executed in the graphics processor 30 based on the positional relationship between the target and the expansion display module 80.

The communication module 50 receives an operation signal from the communication device 90 and outputs the received signal to the system controller 40. The communication device 90 is, for example, a remote controller device (remote controller), a smartphone, a mobile phone, a tablet or a notebook computer.

The OSD processor 60 generates an OSD signal in accordance with the instruction of the signal output from the system controller 30. For example, the OSD processor 60 generates an operational interface screen for supporting the operation input by the user and outputs the interface screen to the graphics processor 30. When the user who referred to the interface screen inputs an operation signal by using the communication device 90, etc., the system controller 30 reflects the content of the operation of the user on the performance of the graphical display device 1.

The detector 70 detects the position and state of an object around the graphical display device 1 and outputs the detected data (analysis result) to the system controller 40. Various types of sensors (a CCD or CMOS image sensor, etc.,) can be applied to the detector 70. When the detector 70 is a miniature camera comprising an image sensor, the detector 70 obtains an image and a picture around the expansion display module 80, identifies an object from the obtained image and picture by an image recognition process and outputs the detection result and identification result to the system controller 40.

The detector 70 is connected to the system controller 40. The detector 70 may be connected to the system controller 40 with a line or may be wirelessly connected to the system controller 40. In case of wireless connection, the detector 70 is connected to the system controller 40 via the communication module 50. More than one detector 70 may be provided. The detector 70 may be provided as a separate module from the graphical display device 1.

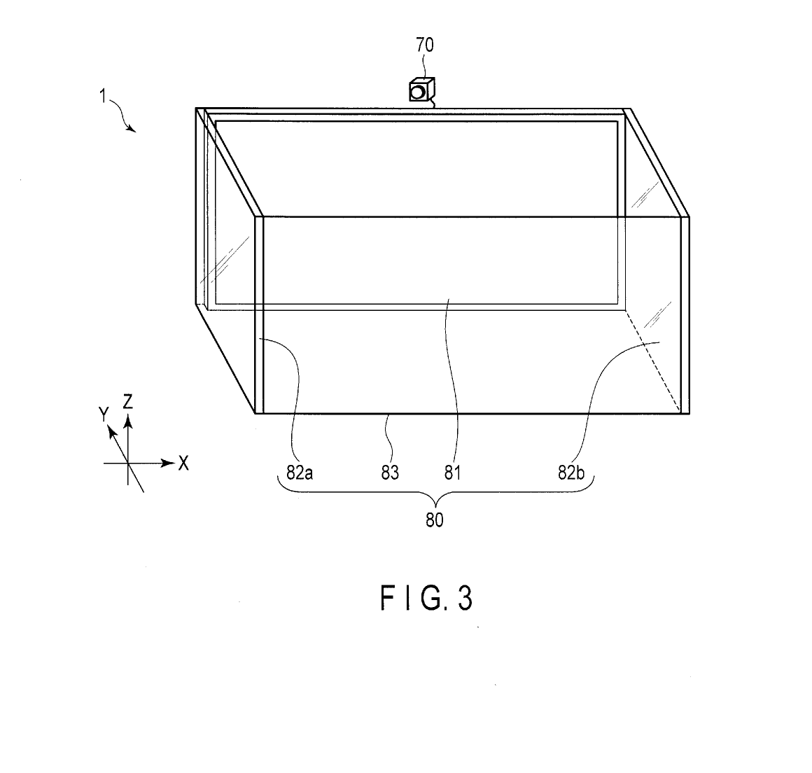

FIG. 3 is a perspective view of the graphical display device 1.

This specification explains a configuration of the expansion display module 80 with reference to FIG. 3.

The expansion display module 80 comprises a display module 81, first and second semi-silvered mirrors 82a and 82b and a polarizing filter 83. The expansion display module 80 displays an expansion display image which is an image (picture) larger than the width of the display screen (central screen) of the display module 81 by using the display module 81 and the first and second semi-silvered mirrors (first and second reflecting members) 82a and 82b.

The display module 81 displays an image and a picture on the central screen. The display module 81 is, for example, a display, and is formed in a rectangular shape having a long axis and a short axis. As shown in FIG. 3, in the display module 81 of the first embodiment, for example, the longitudinal axis is parallel to the X-axis. The X- and Y-axes are orthogonal to each other. The Z-axis perpendicularly crosses both the X- and Y-axes.

Hereinafter, the Z-axial dimension is called the height; the X-axial dimension, the width; and the Y-axial dimension, the depth.

Each of the first and second reflecting members 82a and 82b is formed as a flat plate by a member which reflects light. In the present embodiment, the first and second reflecting members 82a and 82b are semi-silvered mirrors and are hereinafter called first and second semi-silvered mirrors 82a and 82b, respectively. When the polarizing filter 83 (explained later) is provided, the first and second semi-silvered mirrors 82a and 82b are formed by a member which have no polarization property. For example, the first and second semi-silvered mirrors 82a and 82b are formed of glass and acryl, etc. As long as an appropriate expansion display image is shown to the observer, the first and second semi-silvered mirrors 82a and 82b may have a polarization property.

The first and second semi-silvered mirrors 82a and 82b are formed such that one of the surfaces partially reflects light. In the first and second semi-silvered mirrors 82a and 82b, the surface which partially reflects light is called a reflecting surface. Each of the first and second semi-silvered mirrors 82a and 82b is formed by a member which is transmissive and enables observation of the opposite side when each of the first and second semi-silvered mirrors 82a and 82b is observed from the surface opposite to the reflecting surface. In the first and second semi-silvered mirrors 82a and 82b, the transmissive surface is called a transmissive surface.

In the present embodiment, the first and second semi-silvered mirrors 82a and 82b are perpendicular to the display screen of the display module 81 and are provided on both longitudinal ends of the display module 81. The first and second semi-silvered mirrors 82a and 82b are parallel to and face each other. At this time, the first and second semi-silvered mirrors 82a and 82b are formed with the same height as that of the display module 81. The length of each of the first and second semi-silvered mirrors 82a and 82b in the Z-axis is approximately half the width of the display module 81. The reflecting surface of each of the first and second semi-silvered mirrors 82a and 82b is provided toward the display screen side. In the graphical display device 1, the first and second semi-silvered mirrors 82a and 82b are provided such that the reflecting surfaces face each other with the display screen interposed. Thus, the picture (image) displayed in the display module 81 is reflected as a mirror image on the reflecting surface of the first semi-silvered mirror 82a (in other words, in the first expansion display area) and the reflecting surface of the second semi-silvered mirror 82b (in other words, in the second expansion display area).

The polarizing filter 83 transmits light having a specific polarization property. The polarizing filter 83 is, for example, a left-circularly polarizing filter which transmits left-circularly polarized light. The polarizing filter 83 is provided between the target (for example, the observer) and the members including the display module 81, the first semi-silvered mirror 82a and the second semi-silvered mirror 82b. For example, the polarizing filter 83 is provided such that it covers the whole transmissive surfaces of the first and second semi-silvered mirrors 82a and 82b and a position which faces the display screen of the display module 81 between the end portions of the transmissive surfaces. The polarizing film 83 may be formed by a film which is continuous from the transmissive surface of one of the semi-silvered mirrors to the transmissive surface of the other one of the semi-silvered mirrors through the position facing the display module 81. The polarizing film 83 may be formed separately on the transmissive surface of the first semi-silvered mirror 82a, the transmissive surface of the second semi-silvered mirror 82b and the portion facing the display module 81. For example, the polarizing film 83 is formed with the same height as that of the display module 81.

Hereinafter, this specification explains the principle of an expansion display image, assuming that the polarizing filter 83 is a left-circularly polarizing filter 83.

The observer observes the central image (the first image) and the mirror image (the first expansion image and the second expansion image, or the second image) reflected in the first and second semi-silvered mirrors 82a and 82b through the left-circularly polarizing filter 83. In a case where the observer looks inside the expansion display module 80 through the left-circularly polarizing filter 83, the phase of light inverts when mirror reflection is performed on the reflecting surface of each of the first and second semi-silvered mirrors 82a and 82b. In this manner, the central image which is a left-circularly polarized light component is displayed on the central screen. The first expansion image and the second expansion image are displayed in the respective reflecting surfaces. Each of the first expansion image and the second expansion image is a right-circularly polarized light component at the time of emission from the display screen of the display module 81. Each of the first expansion image and the second expansion image inverts in terms of the phase and turns to a left-circularly polarized light component at the time of mirror reflection on the respective reflecting surfaces. At the time of mirror reflection on the reflecting surfaces, the central image is changed from a left-circularly polarized light component to a right-circularly polarized light component, and thus, the central image is blocked by the left-circularly polarizing filter 83. In the above manner, the observer can observe the expansion display image.

Now, this specification explains the relationship between the observation position and the size of the expansion display image. The system controller 40 uses the relationship between the observation position and the size of the expansion display image as described below in order to output the instruction signal of the image process of the expansion display image to the graphics processor 30.

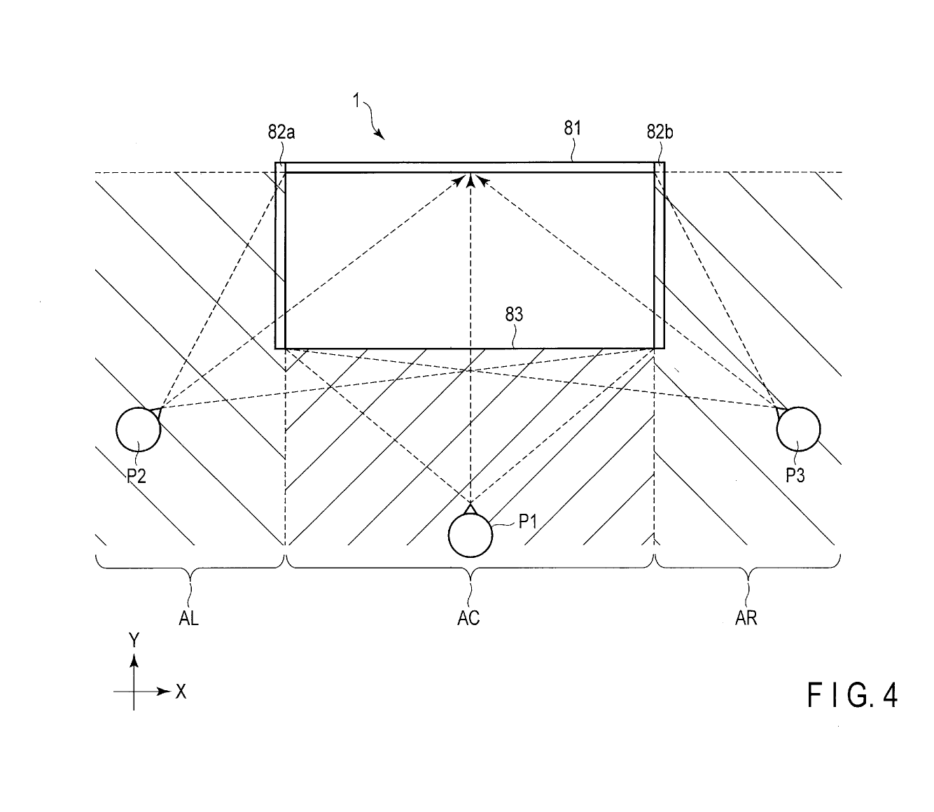

FIG. 4 shows observation areas of the expansion display module 80 of the first embodiment. FIG. 4 shows areas (observation areas) in which the observer observes the expansion display device 80 when the first and second semi-silvered mirrors 82a and 82b are provided. As shown in FIG. 4, the observation area on the front side of the expansion display area 80 is referred to as observation area AC. The observation area adjacent to observation area AC on the first semi-silvered mirror 82a side which is a lateral portion of the expansion display area 80 is referred to as observation area AL. The observation area adjacent to observation area AC on the second semi-silvered mirror 82b side which is a lateral portion of the expansion display area 80 is referred to as observation area AR. In observation area AC, the position of the observer is referred to as observation position P1. In observation area AL, the position of the observer is referred to as observation position P2. In observation area AR, the position of the observer is referred to as observation position P3. The observer may not stay in a certain position. For example, the observer moves from observation area AL to observation area AR through observation area AC.

As shown in FIG. 4, in observation position P1, the observer observes the display module 81 through the polarizing filter 83. In observation position P2, the observer observes the display module 81 through the first semi-silvered mirror 82a and the polarizing filter 83. In observation position P3, the observer observes the display module 81 through the second semi-silvered mirror 82b and the polarizing filter 83.

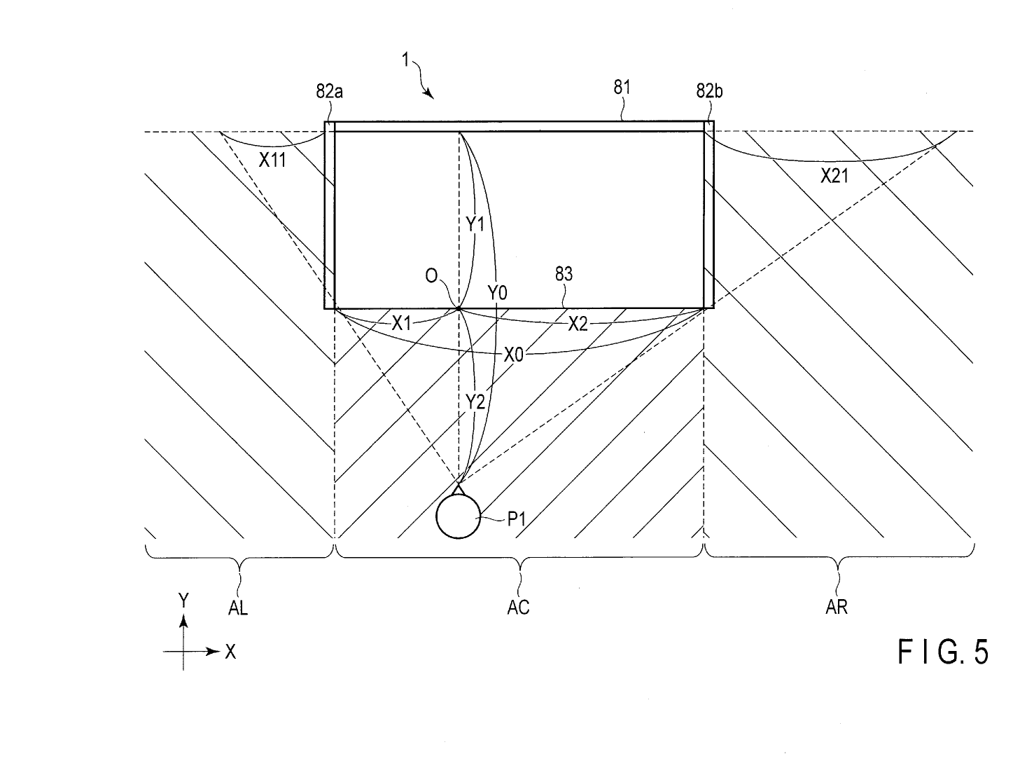

FIG. 5 is a schematic view showing an example of the relationship between an expansion display image and an observation position in the observation area of the front side of the expansion display module 80.

FIG. 5 assumes that the observer observes the display module 81 in observation position P1 of observation area AC. The length of the line from the display screen of the display module 81 to the observer is referred to as Y0. In the line, the distance between the display screen and the polarizing filter is referred to as Y1. In the line, the distance between the polarizing filter and the observer is referred to as Y2. The intersection point of the polarizing filter 83 and the line from the display screen to the observer is referred to as point O. The width of the polarizing filter 83 inside the viewing angle of the observer is referred to as X0. In FIG. 5, for example, the observer keeps the width (X0) between the end portions of the first and second semi-silvered mirrors inside the viewing angle.

The distance between the end portion of the first semi-silvered mirror 82a and point O is referred to as X1. The distance between point O and the end portion of the second semi-silvered mirror 82b is referred to as X2. The relationship is shown by X0=X1+X2. The maximum expansion width of the mirror image reflected on the reflecting surface of the first semi-silvered mirror 82a is referred to as X11. The maximum expansion width of the mirror image reflected on the reflecting surface of the second semi-silvered mirror 82b is referred to as X21. The maximum expansion width (X11) of the mirror image reflected on the reflecting surface of the first semi-silvered mirror 82a is shown by X11=Y1/Y2×X1. The maximum expansion width (X12) of the mirror image reflected on the reflecting surface of the second semi-silvered mirror 82a is shown by X12=Y1/Y2×X2. Thus, as the observer perpendicularly moves away from the polarizing filter 83, the size of the expansion display image which can be observed by the observer is smaller. When the observer perpendicularly moves with respect to the display module 81, the size of the expansion display image which can be observed by the observer is changed in accordance with the distance of the perpendicular move.

When the distance between the display screen and the polarizing filter 83 is equal to the distance between the polarizing filter 83 and the observer (Y1=Y2), the size of the expansion display image which can be observed by the observer by using the whole reflecting surfaces of the first and second semi-silvered mirrors and the whole display screen is 2×. In other words, when the observer observes in a position away from the polarizing filter 83 by the same distance as the distance between the display screen and the polarizing filter 83, the observer can observe a picture or image which is up to twice as large as the picture or image displayed on the display screen of the display module 81.

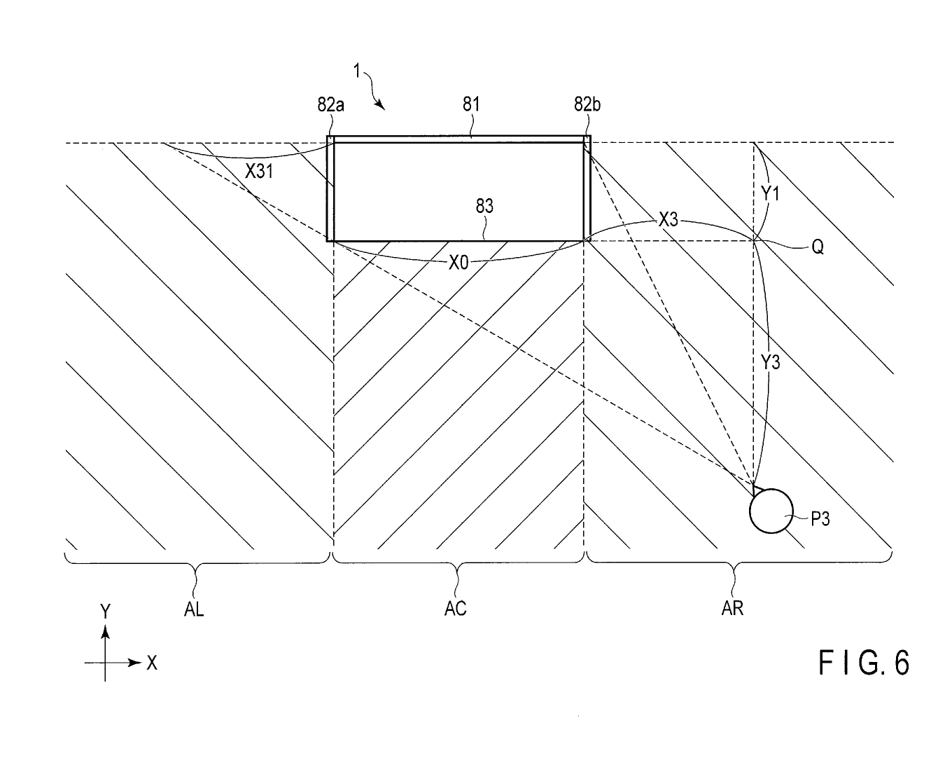

FIG. 6 is a schematic view showing an example of the relationship between an expansion display image and an observation position in an observation area of each lateral portion of the expansion display module 80.

FIG. 6 assumes that the observer observes the display module 81 in observation position P1 of observation area AL or observation area AR. This specification assumes that the observer observes in observation area AR. The distance between the longitudinal end portion of the display module 81 and the observer in the X-axis is referred to as X3. The distance between the display screen and the polarizing filter in the Y-axis is referred to as Y1. The distance between the polarizing filter and the observer in the Y-axis is referred to as Y3. The intersection point of the line perpendicular to the flat surface parallel to the display screen from the observer and the flat surface parallel to the polarizing filter 83 is referred to as point Q. The width of the polarizing filter 83 inside the viewing angle of the observer is referred to as X0. In FIG. 6, for example, the observer keeps the width (X0) between the end portions of the first and second semi-silvered mirrors inside the viewing angle.

The maximum expansion width of the mirror image reflected on the reflecting surface of the first semi-silvered mirror 82a is referred to as X11. The maximum expansion width of the mirror image reflected on the reflecting surface of the second semi-silvered mirror 82b is referred to as X13. If the aforementioned distances are used, the maximum expansion width (X31) of the mirror image reflected on the reflecting surface of the first semi-silvered mirror 82a is shown by X31=Y1/Y3×(X0+X3). As the observer perpendicularly moves away from the polarizing filter 83, the size of the expansion display image which can be observed by the observer is smaller. When the observer moves parallel to the display module 81, the size of the expansion display image which can be displayed by the observer is changed in accordance with the distance of the parallel move.

Now, this specification assumes the following case: the distance between the display screen and the polarizing filter in the Y-axis is equal to the distance between the polarizing filter and the observer in the Y-axis (Y1=Y3), and the width (X0) between the end portions of the first and second semi-silvered mirrors is equal to the distance between the longitudinal end portion of the display module 81 and the observer in the X-axis (X0=X3). In this case, 2X0 is defined as the size of the expansion display image which can be observed by the observer by using the whole reflecting surfaces of the first and second semi-silvered mirrors and the whole display screen. Thus, the observer observes in a position which is away from the polarizing filter 83 by the same distance as the distance between the display screen and the polarizing filter 83 in the Y-axis and which is away from the reflecting surface of the second semi-silvered mirror 82b by the same distance as the width (X0) between the end portions of the first and second semi-silvered mirrors in the x-axis and the distance between the observer and the longitudinal end portion of the display module 81 in the X-axis. In this case, the observer can observe a picture or image which is up to twice as large as the picture or image displayed on the display screen of the display module 81.

The system controller 40 uses the relationship between the observation position and the size of the expansion display image as described above, sets the size of the expansion display image, the divisional positions of the image, the divisional ratio of the image and the like and outputs them as an instruction signal to the graphics processor 30.

Now, this specification explains an expansion display image corresponding to the observation position of the observer with reference to the drawings.

First, this specification explains the generation of an expansion display image corresponding to the observation position in the graphical display device 1 according to the present embodiment.

The system controller 40 of the graphical display device 1 detects a person when the detector 70 confirms an object in each observation area. The system controller 40 determines whether or not the person faces the display module 81 based on the posture of the person and the orientation of the face and eyes (line of sight). When the system controller 40 confirms that the person observes the display module 81 for a certain period, the system controller 40 sets the person as the observer. Apart from this setting, when the detector 70 detects the first person who enters the detection area, the system controller 40 may set the person as the observer. The system controller 40 may arbitrarily set the observer in accordance with the instruction by the user.

The system controller 40 calculates the position (for example, the above-described P1, P2 or P3) of the observer based on the detection data of the detector 70. Based on the position (for example, the above-described P1, P2 or P3) of the observer, the system controller 40 calculates the length (for example, the above-described X0) of the central image 3M and the lengths (for example, the above-described X11, X21 and X31) of the first and second expansion images 3LR and 3RR in such a way that the lengths are suitable for the observation of the display screen of the display module 81. The system controller 40 outputs the calculation data (result) as a signal to the graphics processor 30.

The graphics processor 30 generates the central image data 3M and the first and second expansion image data 3L and 3R having the lengths calculated based on the output signal of the system controller 40. The graphics processor 30 supplies the horizontal line image data items of the central image data 3M to the pixel circuits of the respective odd-numbered display lines of the expansion display module 80. The graphics processor 30 supplies the horizontal line image data items of the first inversion image data 3LR and the second inversion image data 3RR to the pixel circuits of the respective even-numbered display lines of the expansion display module 80.

The system controller 40 is also configured to arbitrarily control the position of the observer, the generation of the expansion display image, etc., in accordance with the signal from the communication device.

In the above manner, the graphical display device 1 generates an expansion display image corresponding to the observation position.

Now, this specification shows some examples of image processes corresponding to predetermined observation positions. In the examples shown below, the graphical display device 1 provides the observer in an observation position with an expansion display image which is twice as wide as the width of the display area of the display module 81 in each observation area.

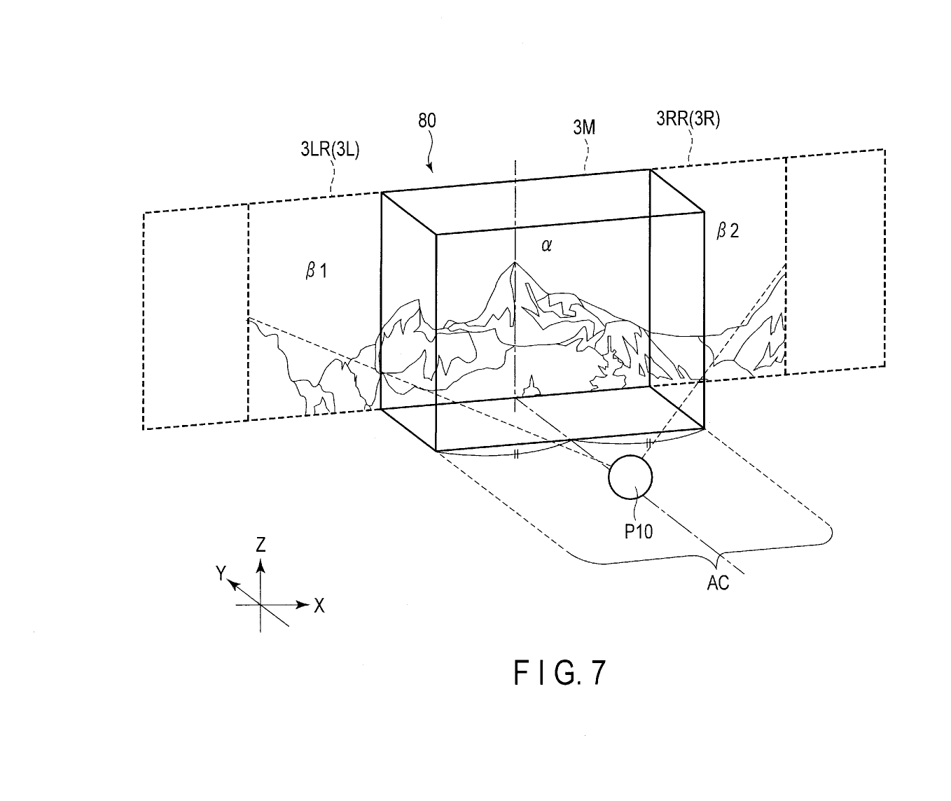

FIG. 7 is a schematic view showing an example of an expansion display image when observation is performed in the central position of observation area AC of the front side of the expansion display module 80.

The detector 70 detects observation position P10 in a position facing the center of the display screen of the display module 81 in observation area AC. In the image process shown in FIG. 2, the graphics processor 30 generates the central image 3M, the first expansion image 3L and the second expansion image 3R from the image which is input in accordance with the signal of the system controller 40. At this time, the length of the central image 3M is half of the whole expansion display image. The length of the first expansion image 3L is a quarter of the whole expansion display image. The length of the second expansion image 3R is a quarter of the whole expansion display image. The graphics processor 30 inverts the first expansion image 3L and generates the first inversion image 3LR. The graphics processor 30 inverts the second expansion image 3R and generates the second inversion image 3RR. The graphics processor 30 supplies each of the generated images to a predetermined display line of the expansion display module 80.

As a result, as shown in FIG. 7, the graphical display device 1 can provide the observer with the central image 3M on the central screen, the first expansion image 3L as the mirror image of the first expansion image 3LR on the reflecting surface of the first semi-silvered mirror 82a and the first expansion image 3R as the mirror image of the second expansion image 3RR on the reflecting surface of the second semi-silvered mirror 82b.

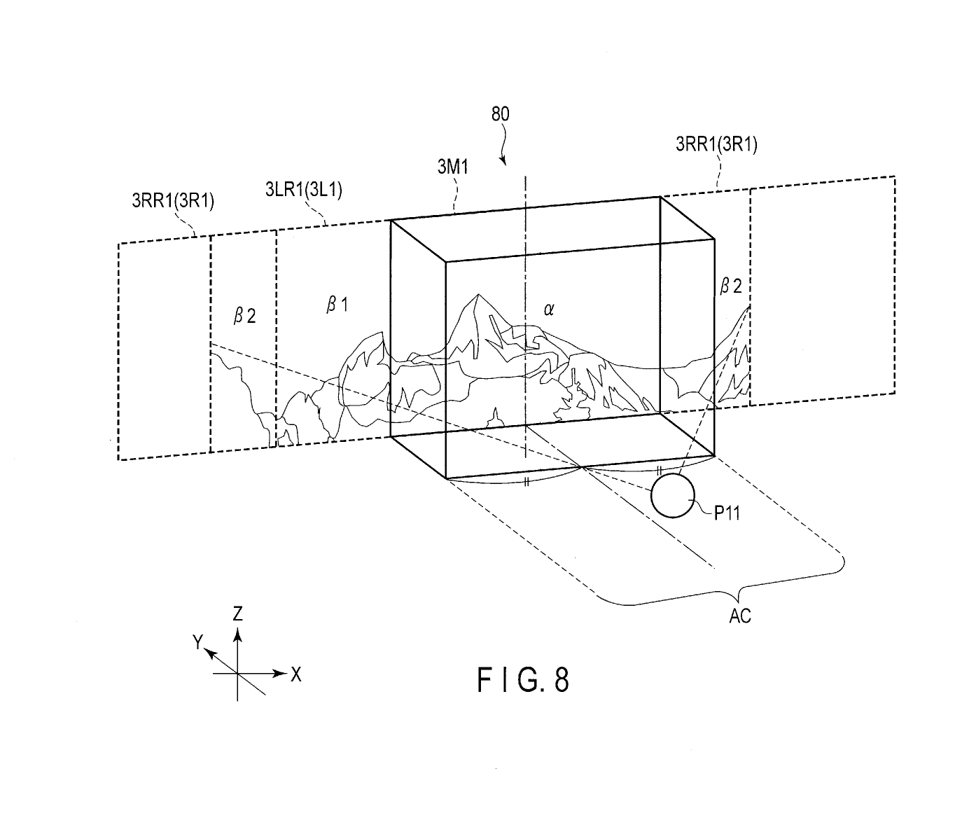

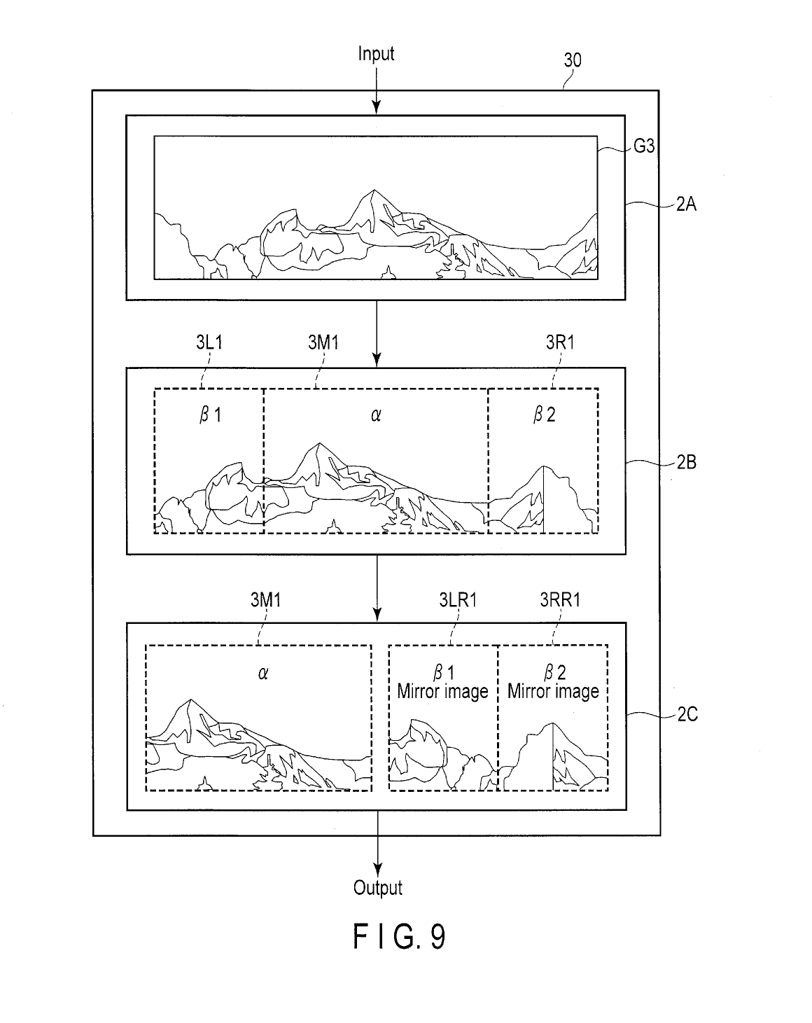

FIG. 8 is a schematic view showing an example of an expansion display image when observation is performed in a position other than the central position of observation area AC of the front side of the expansion display module 80. FIG. 9 shows the image process of the graphics processor 30 in case of FIG. 8.

The detector 70 detects observation position P11 which is a position other than the central position of the display screen of the display module 81 in observation area AC. For example, observation position P11 is a position which is moved from the reflecting surface of the second semi-silvered mirror 82b by a quarter of the width of the display area toward the center of observation area AC. In image processing step 2A shown in FIG. 9, the graphics processor 30 shifts one-eighths of the whole expansion display image in one of the longitudinal directions, for example, in the left direction, in a manner corresponding to the direction and distance of the move of the observer.

When the image is longitudinally shifted, the same piece of the input image G3 is connected to both longitudinal end portions of the input image G3. Therefore, as shown in image processing step 2B of FIG. 9, the expansion display image to which the image process is applied is in a state where one-eighths of the whole image is shifted. In image processing step 2B, the graphics processor 30 generates a central image 3M1, a first expansion image 3L1 and a second expansion image 3R1 from the image prepared by shifting one-eighths of the whole expansion display image. The length of the central image 3M is half of the whole expansion display image. The length of the first expansion image 3L1 is a quarter of the whole expansion display image. The length of the second expansion image 3R1 is a quarter of the whole expansion display image. The graphics processor 30 inverts the first expansion image 3L1 and generates a first inversion image 3LR1. The graphics processor 30 inverts the second expansion image 3R1 and generates a second inversion image 3RR1. The graphics processor 30 supplies each of the generated images to a predetermined display line of the expansion display module 80.

As a result, as shown in FIG. 9, the graphical display device 1 can provide the observer with the second expansion image 3M1 on the central screen, and the first expansion image 3L1 as the mirror image of the first inversion image 3LR1 and half of the second expansion image 3R1 (one-eights of the whole image) as the mirror image of half of the second inversion image 3RR1 on the reflecting surface of the first semi-silvered mirror 82a. Moreover, the graphical display device 1 can provide half of the second expansion image 3R1 (one-eights of the whole image) as the mirror image of half of the second expansion image 3RR1 (one-eighths of the whole image) on the reflecting surface of the second semi-silvered mirror 82b.

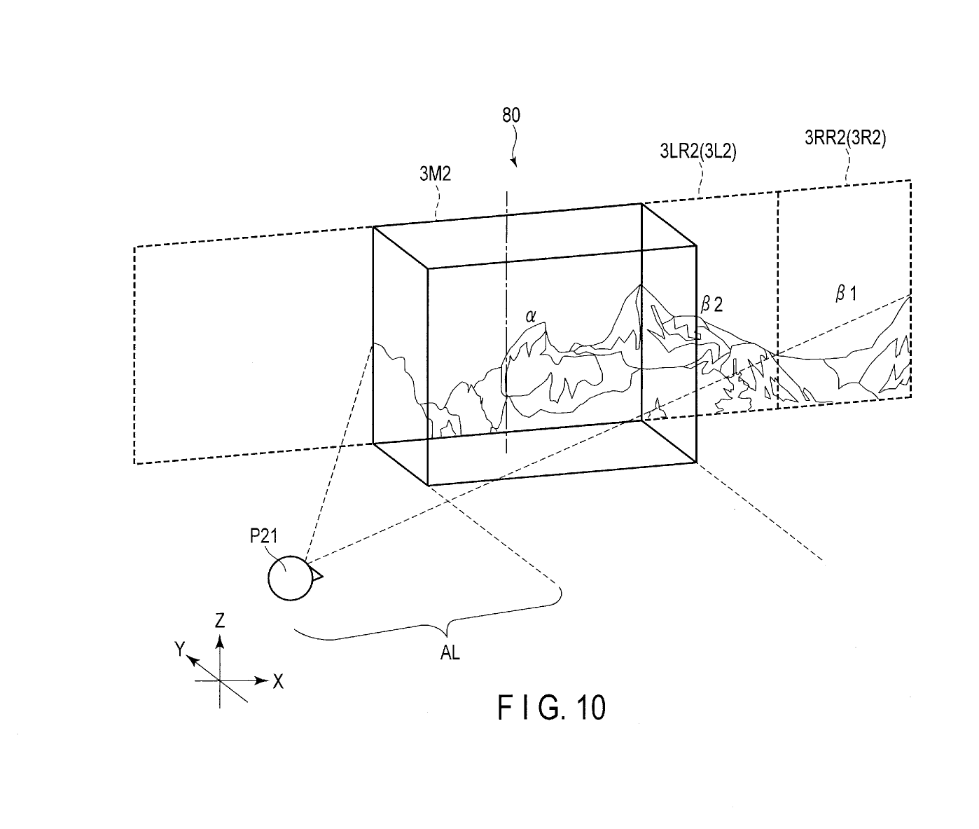

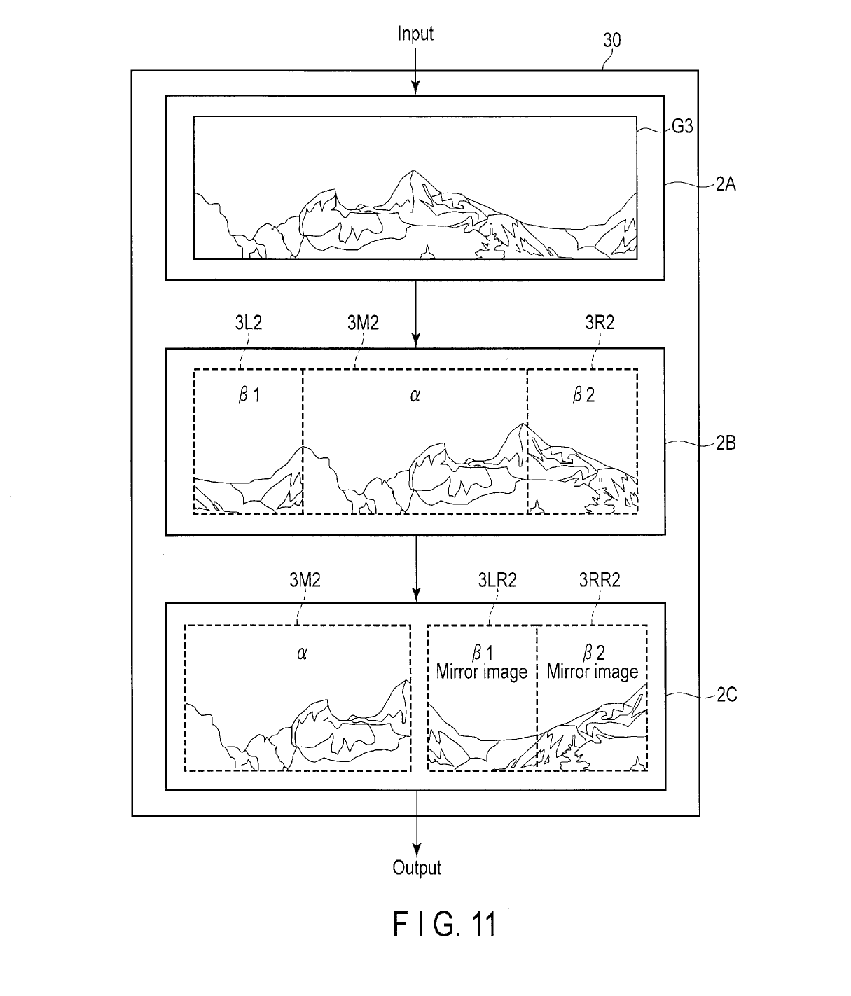

FIG. 10 is a schematic view showing an example of an expansion display image when observation is performed in observation area AL of the outer side of the first semi-silvered mirror 82a. FIG. 11 shows the image process of the graphics processor 30 in case of FIG. 10.

The detector 70 detects observation position P21 in observation area AL. For example, observation position P21 is a position which is moved from the reflecting surface of the first semi-silvered mirror 82a by distance X0 which is the same as the width of the display area toward the outer side of the expansion display module 80 in the X-axis. In image processing step 2A shown in FIG. 11, the graphics processor 30 shifts a quarter of the whole expansion display image in one of the longitudinal directions, for example, in the right direction, in a manner corresponding to the direction and distance of the move of the observer.

When the image is longitudinally shifted, the same piece of the input image G3 is connected to both longitudinal end portions of the input image G3. Therefore, as shown in image processing step 2B of FIG. 11, the expansion display image to which the image process is applied is in a state where a quarter of the whole image is shifted. In image processing step 2B, the image prepared by shifting a quarter of the whole expansion display image is divided into a central image 3M2, a first expansion image 3L2 and a second expansion image 3R2. The length of the central image 3M2 is half of the whole expansion display image. The length of the first expansion image 3L2 is a quarter of the whole expansion display image. The length of the second expansion image 3R2 is a quarter of the whole expansion display image. Moreover, the graphics processor 30 inverts the first expansion image 3L2 and generates a first inversion image 3LR2. The graphics processor 30 inverts the second expansion image 3R2 and generates a second inversion image 3RR2. The graphics processor 30 supplies each of the generated images to a predetermined display line of the expansion display module 80.

As a result, as shown in FIG. 10, the graphical display device 1 can provide the observer with the central image 3M2 on the central screen, and the first expansion image 3L2 as the mirror image of the first inversion image 3RL2 and the second expansion image 3R2 as the mirror image of the second expansion image 3RR2 on the reflecting surface of the second semi-silvered mirror 82b.

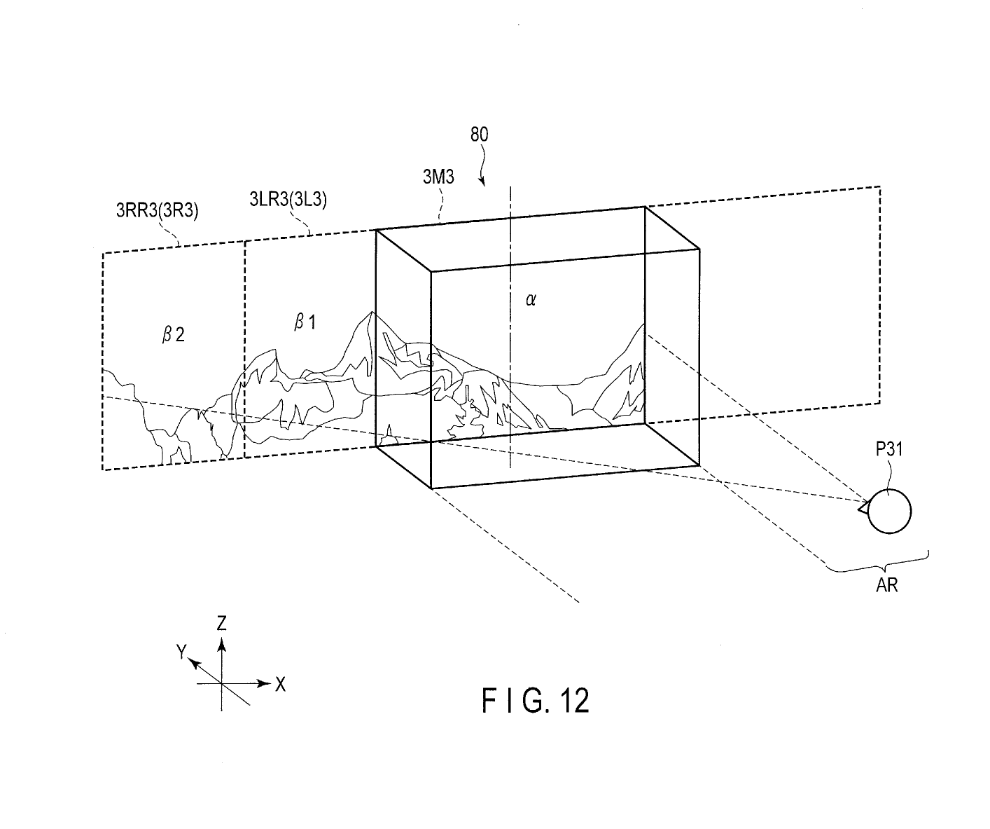

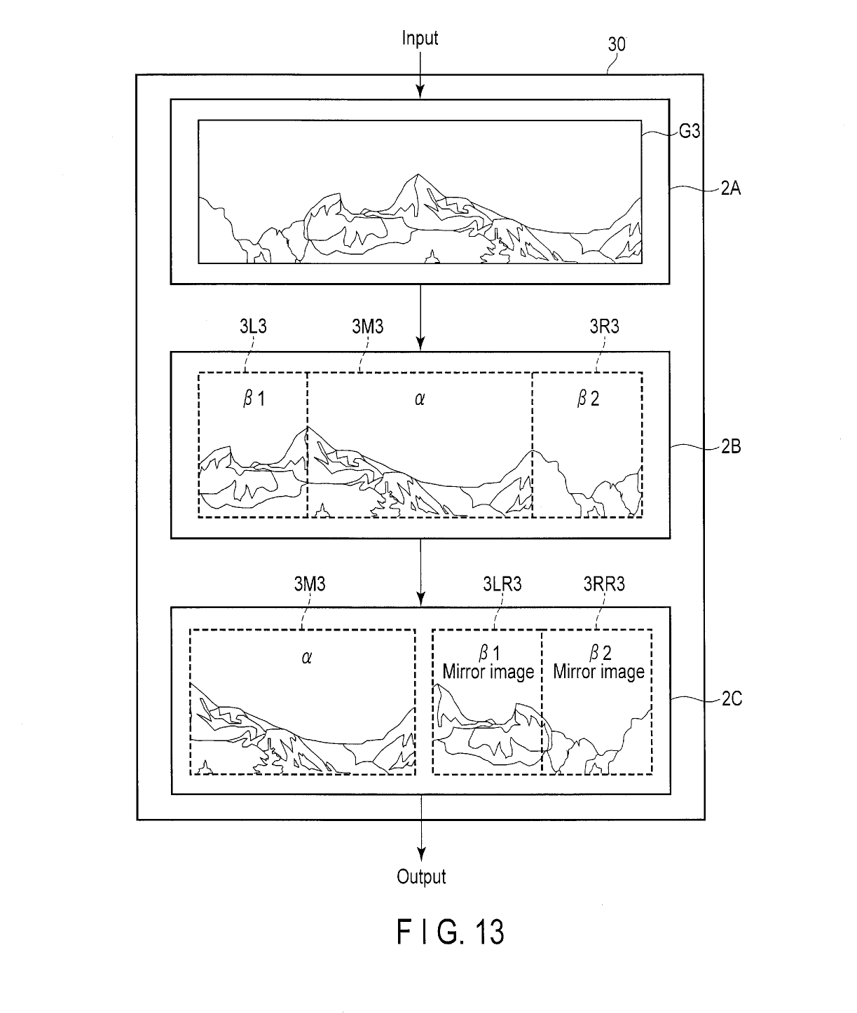

FIG. 12 is a schematic view showing an example of an expansion display image when observation is performed in observation area AL of the outer side of the second semi-silvered mirror 82b. FIG. 13 shows the image process of the graphics processor 30 in case of FIG. 12.

The detector 70 detects observation position P31 in observation area AR. For example, observation position P31 is a position which is moved from the reflecting surface of the second semi-silvered mirror 82b by distance X0 which is the same as the width of the display area toward the outer side of the expansion display module 80 in the X-axis. In other words, observation position P31 shown in FIG. 13 is a position in the observation area opposite to that of observation position P21 shown in FIG. 11 in the X-axis.

In image processing step 2A shown in FIG. 13, the graphics processor 30 shifts a quarter of the whole expansion display image in one of the longitudinal directions, for example, in the left direction, in a manner corresponding to the direction and distance of the move of the observer. The shift direction of the expansion display image in image processing step 2A of FIG. 13 is opposite to the shift direction of the expansion display image in image processing step 2A of FIG. 11. For example, when the shift direction of the expansion display image in image processing step 2A of FIG. 11 is longitudinally rightward, the shift direction of the expansion display image in image processing step 2A of FIG. 13 is longitudinally leftward.

When the image is shifted, the same piece of the input image G3 is connected to both longitudinal end portions of the input image G3. Therefore, as shown in image processing step 2B of FIG. 13, the expansion display image to which the image process is applied is in a state where a quarter of the whole image is shifted. In image processing step 2B, the graphics processor 30 generates a central image 3M, a first expansion image 3L3 and a second expansion image 3R3 from the image which is input in accordance with the signal of the system controller 40. The length of the central image 3M3 is half of the whole expansion display image. The length of the first expansion image 3L3 is a quarter of the whole expansion display image. The length of the second expansion image 3R3 is a quarter of the whole expansion display image. Moreover, the graphics processor 30 inverts the first expansion image 3L3 and generates a first inversion image 3LR3. The graphics processor 30 inverts the second expansion image 3R3 and generates a second inversion image 3RR3. The graphics processor 30 supplies each of the generated images to a predetermined display line of the expansion display module 80.

As a result, as shown in FIG. 12, the graphical display device 1 can provide the observer with the central image 3M3 on the central screen, and the first expansion image 3L3 as the mirror image of the first inversion image 3RL3 and the second expansion image 3R3 as the mirror image of the second expansion image 3RR3 on the reflecting surface of the first semi-silvered mirror 82a.

Apart from the above examples of the image processes corresponding to the observation positions, the graphical display device 1 executes various types of image processes corresponding to observation positions.

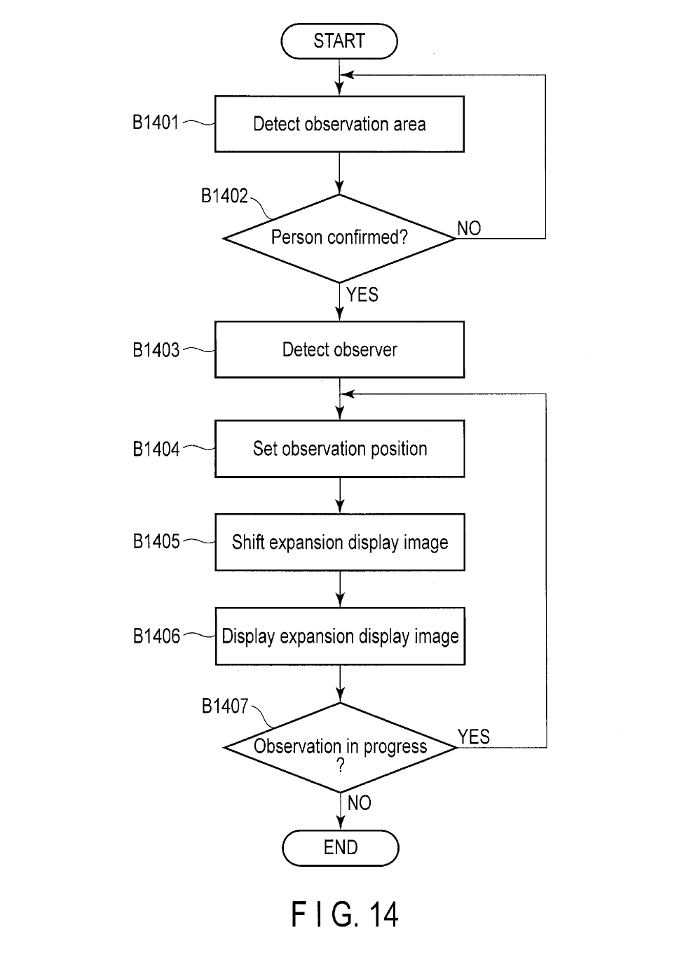

FIG. 14 shows a flowchart for automatically generating an expansion display image by the system controller 40. The system controller 40 may generate an expansion display image in accordance with the instruction by the user through the communication device 90. In other words, the user may generate an expansion display image by hand.

In step B1401, for example, the detector 70 detects an object in the observation area or an object which enters the observation area.

In step B1402, the system controller 40 identifies whether or not the object detected by the detector 70 is a person.

In step B1403, the system controller 40 sets a person whose body, face and eyes face the display screen of the display module 81 for a certain period as the observer based on the detection result of the detector 70.

In step B1404, the system controller 40 sets the observation area and position where the observer is present as the observation position based on the detection result of the detector 70.

In step B1405, the system controller 40 calculates the distance between the observation position and each module of the expansion display module 80. For example, the graphics processor 30 longitudinally shifts the expansion display image and divides the expansion display image into the central image displayed on the central screen, the first expansion image displayed in the first expansion display area and the second expansion image displayed in the second expansion display area in a predetermined ratio in a manner corresponding to the observation position based on the calculation result of the system controller 40. For example, the graphics processor 30 shifts the expansion display image and adjusts the divisional ratio of the input image such that the observer can comfortably observe the expansion image which is twice as large as the central image in the observation position. The graphics processor 30 inverts the first and second expansion images of the divided input image G3 and generates the first and second inversion images. The graphics processor 30 reallocates the central image and the first and second inversion images, and outputs them as an expansion display image to the expansion display module 80.

In step B1406, the expansion display module 80 displays the expansion image on the display screen of the display module 81. Each of the first and second inversion images provided in the even-numbered lines of the expansion image displayed in the display module 81 is a right-circularly polarized light component in the display module 81. Each of the first and second inversion images is reflected as a mirror image in the first or second expansion display area and turns to a left-circularly polarized light component. As a result, the expansion display module 80 displays an expansion display image composed of the central image displayed on the display screen, the first expansion image displayed in the first expansion display area and the second expansion image displayed in the second expansion display area through the polarizing filter 83 which is a left-circularly polarizing filter.

In step B1407, the system controller 40 determines again whether or not the observer observes the expansion display module 80 in progress based on the detection result of the detector 70. When the system controller 40 determines that the observation is in progress (YES in step B1407), the system controller 40 returns to step B1404 and outputs an expansion image suitable for the current position of the observer as the instruction signal of an image process to the graphics processor 30.

When the system controller 40 determines that the observation is not in progress (NO in step B1407), the system controller 40 terminates the process and detects an object in the observation area.

The above expansion display image corresponding to the observation position of the observer is generated in accordance with various use cases in addition to the case of the flowchart shown in FIG. 14. For example, when the direction of the move of a person is limited as a use case (a pedestrian conveyor belt, an escalator, etc.,), the display ratio of the side to which the person moves is made greater.

In such a case, in order to provide the observer with a continuous picture or image which is twice as large as the central image, the graphics processor 30 may process an expansion display image in a divisional ratio different from the above-described divisional ratio in accordance with the instruction signal of the system controller 40 or may process an expansion display image in a divisional ratio different from the above-described divisional ratio in a manner corresponding to the observation distance.

Moreover, the graphics processor 30 may process an expansion display image in a shift ratio different from the above-described shift ratio in accordance with the instruction signal of the system controller 40 or may process an expansion display image in a shift ratio different from the above-described shift ratio in a manner corresponding to the observation distance.

When an expansion display image is manually generated, the generation may be performed in line with the following flow chart. A part of the flowchart may be separately performed for each instruction. When an expansion display image is manually generated, the graphics processor 30 may execute an image process different from that of the above-described flowchart in accordance with the signal of the communication module 90.

In the present embodiment, the graphical display device 1 comprises the first and second semi-silvered mirrors 82a and 82b, and the polarizing filter between the expansion display module 80 and the observer. As a result, the graphical display device 1 of the present embodiment is configured to provide an expansion image in all of the orientations of the front side of the display module 81 of the display expansion display module 80.

The graphical display device 1 arbitrarily detects the position and state of the observer in the detector 70 or automatically detects the position and state of the observer in the detector 70 by using the system controller 40. As a result, the graphical display device 1 can provide an expansion display image which can be comfortably observed in the position of the observer in an arbitrary manner and in an automatic manner by the system controller 40.

In the first embodiment, the display screen of the display module 81 of the expansion display module 80 is provided so as to point in the Y-direction. However, the display screen may be provided so as to point in other directions as long as the first and second semi-silvered mirrors are perpendicular to the display screen on both longitudinal end portions of the display module 81.

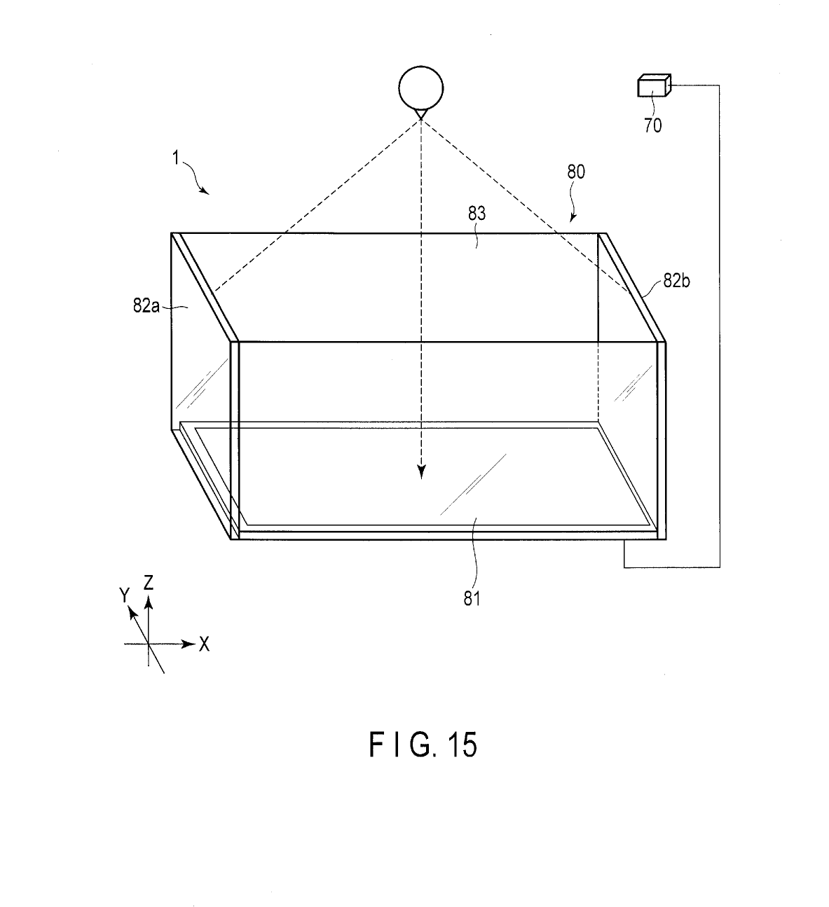

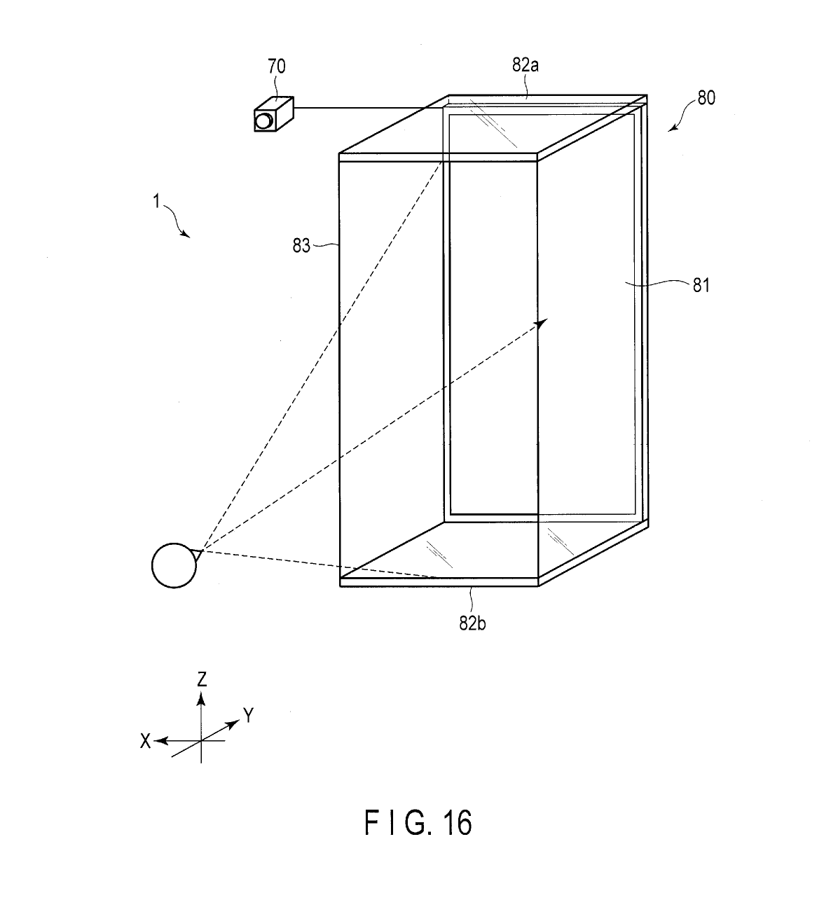

As shown in FIG. 15, the expansion display module 80 may be provided such that the display screen of the display module 81 points in the Z-direction. In this case, for example, the expansion display module 80 is provided on the floor or ceiling. As shown in FIG. 16, the expansion display module 80 may be provided such that the expansion display module 80 of the first embodiment is rotated at 90 degrees. In other words, the expansion display module 80 is provided such that its long axis is parallel to the Z-axis and its short axis is parallel to the Z-axis. In this manner, it is possible to provide the graphical display module 1 comprising the expansion display module 80 suitable for the use case in terms of the layout.

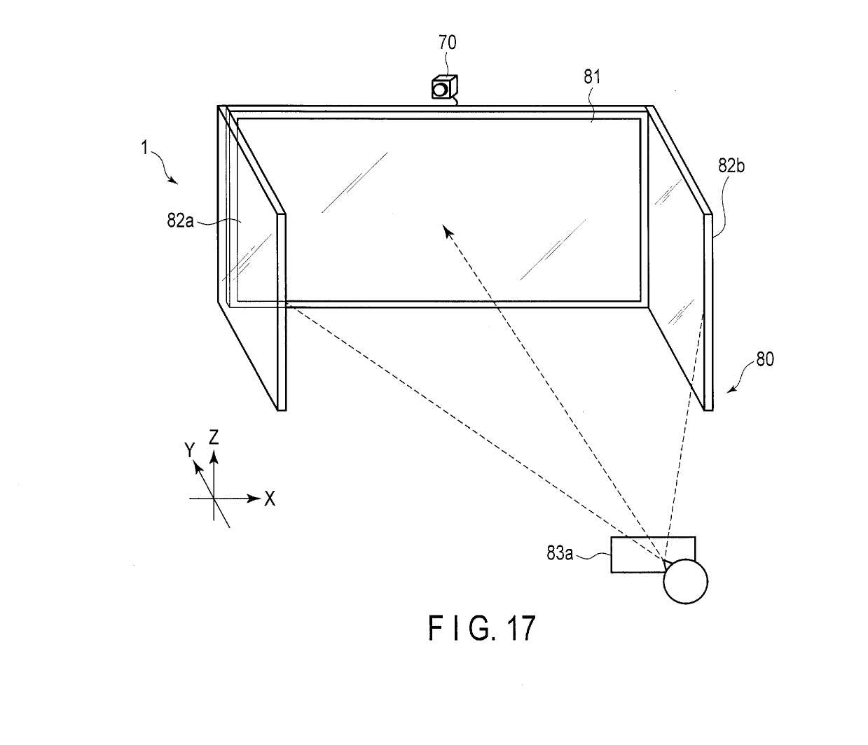

In the first embodiment, the polarizing filter 83 may be provided in a position different from the first embodiment as long as the position is between the observer and the display module 81. As shown in FIG. 17, a polarizing filter 83a may be provided right in front of the observer. In this case, the polarizing filter 83a is, for example, glasses comprising a lens portion comprising a polarizing filter. When the polarizing filter 83 is provided in this manner, the graphical display device 1 can provide the observer with an expansion display image even without a polarizing filter in the expansion display module 80.

This specification turns to the explanation of a graphical display device according to another embodiment. In the embodiments described below, the elements identical to those of the first embodiment are denoted by the same reference numbers and symbols. Thus, the detailed explanation of such elements is omitted.

### Second Embodiment

The semi-silvered mirrors are replaced by mirrors in a graphical display device 1 in a second embodiment.

In an expansion display module 80 of the present embodiment, one of the surfaces of each of first and second mirrors 84a and 84b is formed so as to partially reflect light. In each of the first and second mirrors 84a and 84b, the surface which partially reflects light is referred to as a reflecting surface. The first and second mirrors 84a and 84b may be members other than mirrors as long as they reflect light. For example, the first and second mirrors 84a and 84b may be lustrous metal.

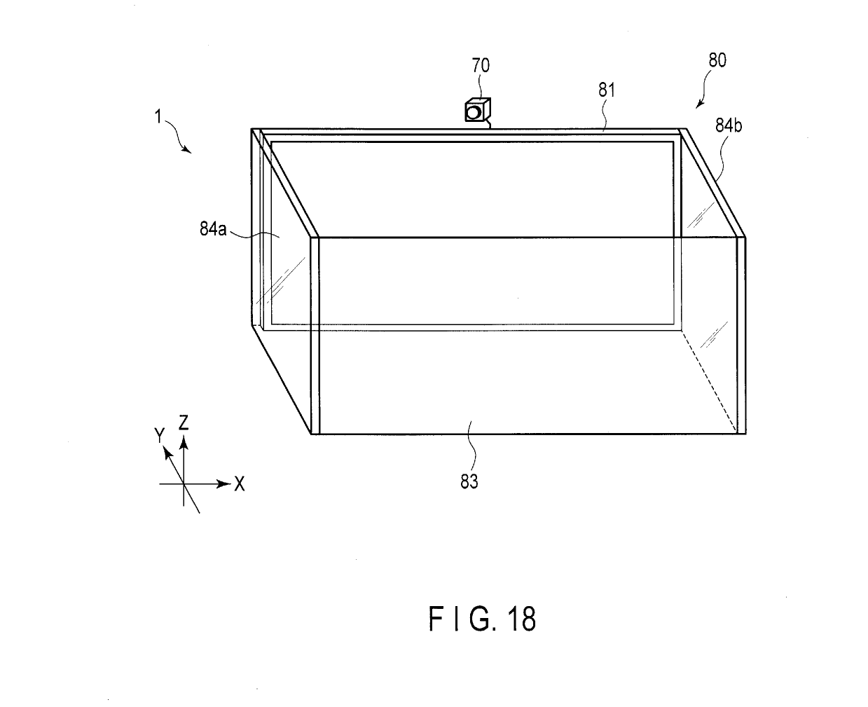

FIG. 18 is a perspective view of the graphical display device 1 of the present embodiment.

In the present embodiment, each of the first and second mirrors 84a and 84b is formed and provided substantially in the same manner as the first embodiment. In the graphical display device 1, the first and second mirrors 84a and 84b are provided such that the reflecting surfaces face each other with the display screen of the display module 81 interposed. Thus, the picture (image) displayed in the display module 81 is reflected as a mirror image on the reflecting surface (a first expansion display area) of the first mirror 84a and the reflecting surface (a second expansion display area) of the second mirror 84b.

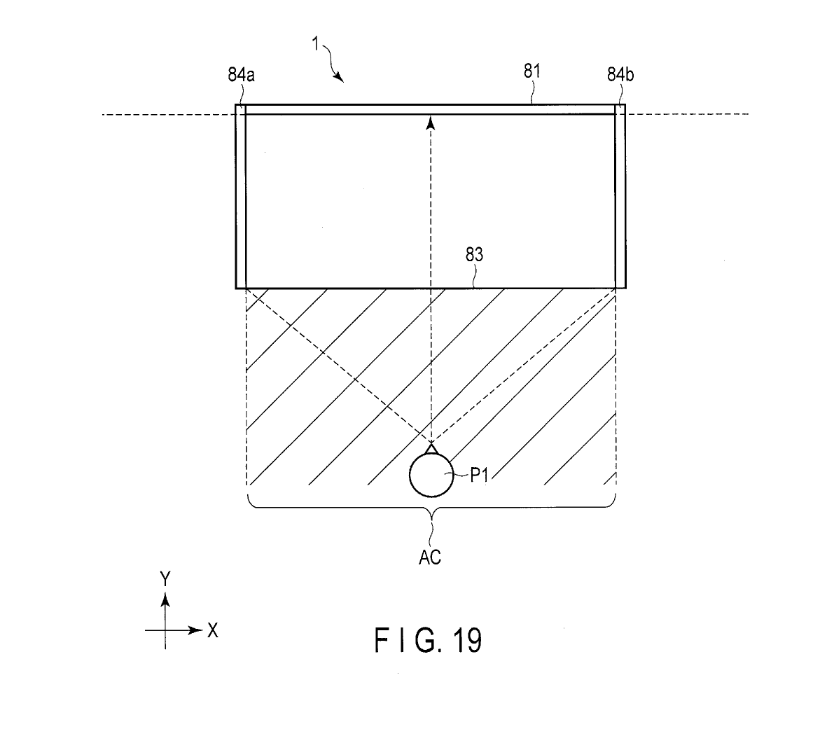

FIG. 19 shows observation area AC of the graphical display device 1 of the present embodiment. As shown in FIG. 19, the graphical display device 1 of the present embodiment can provide the observer positioned in observation area AC with an expansion display image corresponding to the observation position.

The graphical display device 1 of the second embodiment can provide an expansion display image by allocating a member which reflects light other than a semi-silvered mirror.

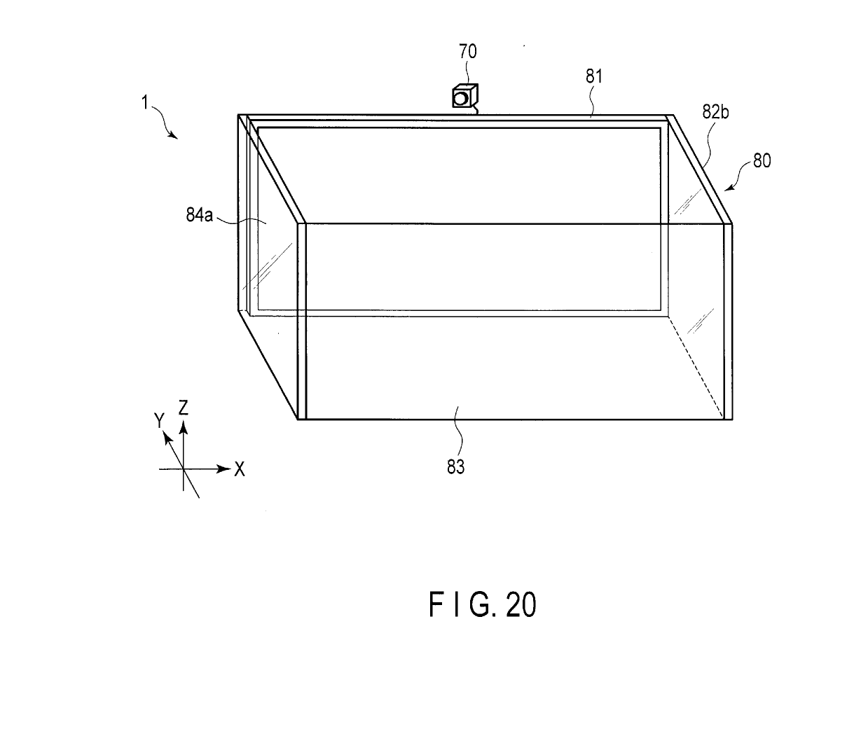

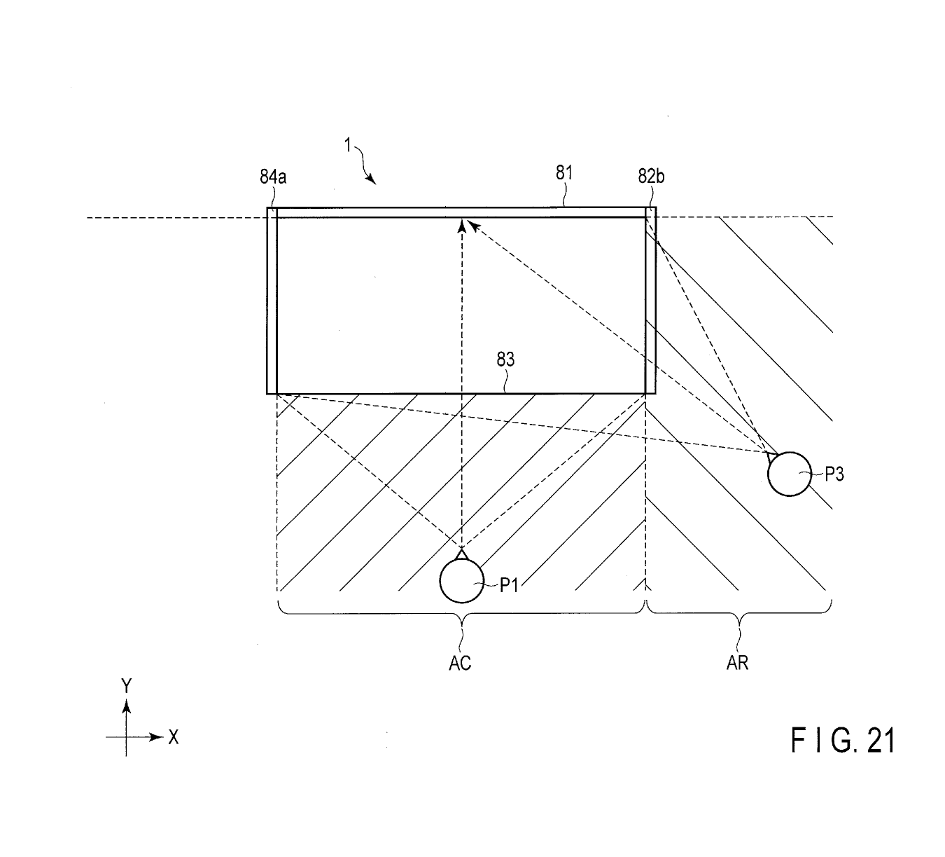

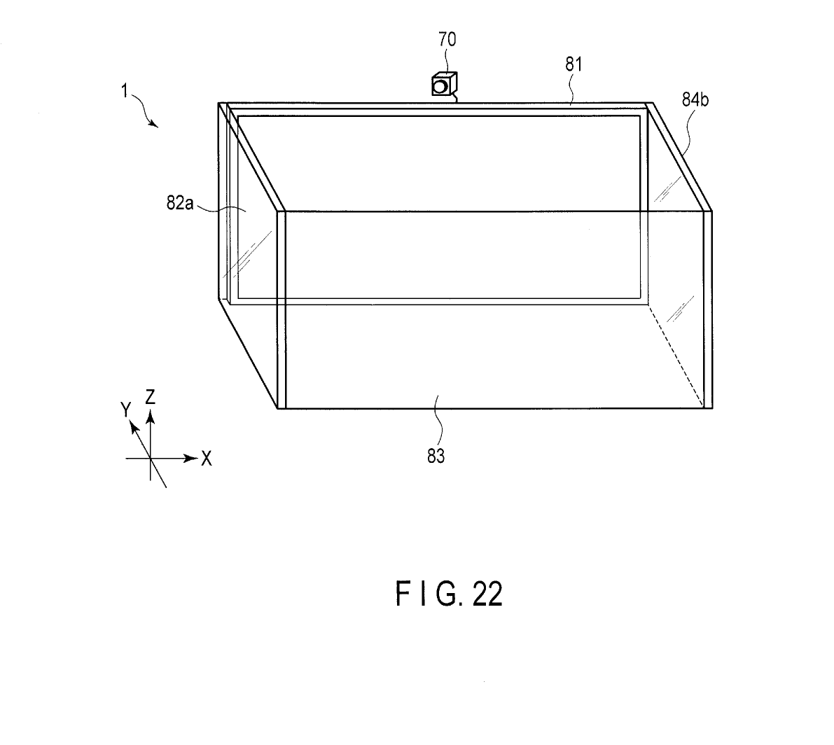

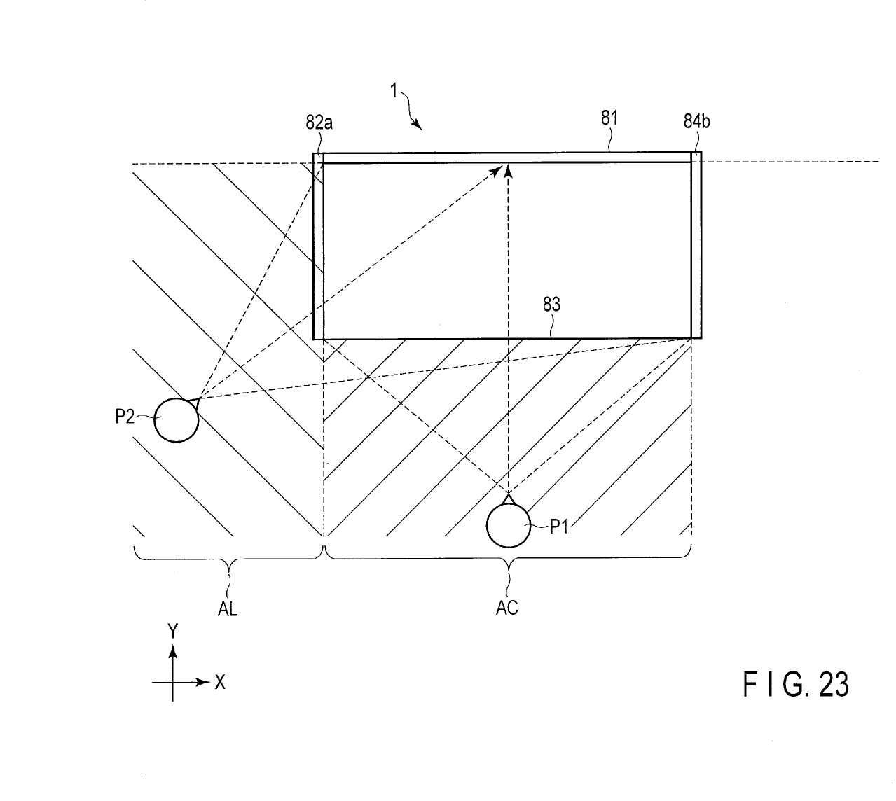

In the second embodiment, one of the first and second mirrors 84a and 84b may be a semi-silvered mirror. For example, as shown in FIG. 20, the second mirror 84b may be a second semi-silvered mirror 82b. In this case, as shown in FIG. 21, the graphical display device 1 can provide the observer positioned in observation area AC of the front side and the observer positioned in observation area AR of the lateral portion in which the second semi-silvered mirror 82b is provided with an expansion display image. For example, as shown in FIG. 22, the first mirror 84a may be a first semi-silvered mirror 82a. In this case, as shown in FIG. 23, the graphical display device 1 can provide the observer positioned in observation area AC of the front side and the observer positioned in observation area AL of the lateral portion in which the first semi-silvered mirror 82a is provided with an expansion display image.

### Third Embodiment

In a graphical display device 1 of a fourth embodiment, one of the semi-silvered mirrors or one of the mirrors is removed from each of the above-described embodiments.

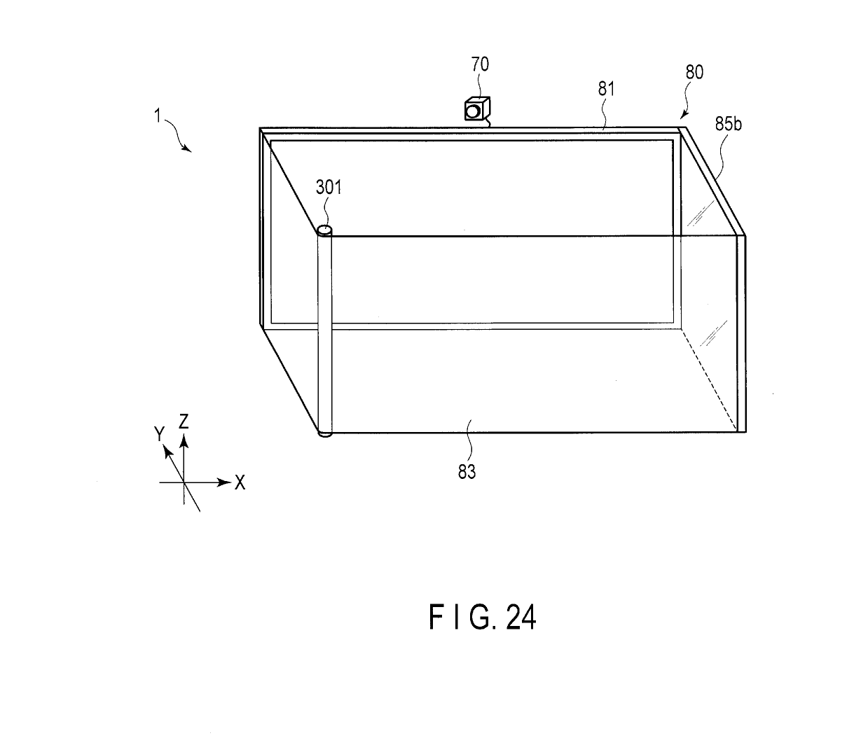

FIG. 24 is a schematic view showing an example of the graphical display device 1 according to the present embodiment.

In the present embodiment, an expansion display module 80 comprises a display module 81, a polarizing filter 83, a reflecting member 85b and a supporting member 301. The reflecting member 85b may be provided in the opposed position.

In the present embodiment, the reflecting member 85b is, for example, a member which reflects light such as a semi-silvered mirror or a mirror. The reflecting member 85b is formed and provided substantially in the same manner as the semi-silvered mirrors 82a and 82b and the mirrors 84a and 84b of the aforementioned embodiments. An end portion of the reflecting member 85b is connected to a longitudinal end portion of the display module 81 and is provided so as to be perpendicular to the display screen of the display module 83. In the graphical display device 1, the reflecting member 85b is provided so as to face a reflecting surface which reflects light on the display screen side of the display module 81. Thus, the picture (image) displayed in the display module 81 is reflected as a mirror image on the reflecting surface of the reflecting member 85b (in other words, in a third expansion display area).

In the present embodiment, the polarizing film 83 is provided from the other end portion of the reflecting member 85b (on the side opposite to the end portion connected to the display module 81) to an end portion of the display module 81.

The supporting member 301 supports the polarizing film 83 between an end portion of the display module 81 and the reflecting member 85b.

In the graphical display device 1 of the present embodiment, the number of members such as semi-silvered mirrors or mirrors can be reduced compared to the above embodiments.

In the present embodiment, the supporting member 301 may not be provided if the polarizing film 83 can be provided between the observer and the members including the display module 81 and the reflecting member 85b.

In the above embodiments, the reflecting members such as semi-silvered mirrors or mirrors are perpendicularly connected to both longitudinal end portions of the display module 81. However, the reflecting members may be provided away from the longitudinal end portions, and may not be perpendicular to the display module 81. The reflecting members need to be provided in positions which reflect the picture and image displayed in the display module 81.

In the above embodiments, the graphical display device 1 can provide an expansion image in all of the orientations of the front side of the display module 81 of the display expansion display module 80.

The graphical display device 1 arbitrarily detects the position and state of the observer in the detector 70 or automatically detects the position and state of the observer in the detector 70 by using the system controller 40. As a result, the graphical display device 1 can provide an expansion display image which can be comfortably observed in the position of the observer in an arbitrary manner and in an automatic manner by the system controller 40.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A graphical display device comprising:
a display module configured to display a picture comprising a first image which is a first circularly polarized light component and a second image which is a second circularly polarized light component opposite in polarization to the first circularly polarized light component;
at least one reflecting member configured to display the second image included in the picture displayed in the display module as a mirror image;
an observation position setting module configured to set an observation position indicating a position in which the display module and the reflecting member are observed;
a graphics processor configured to generate the first image and the second image by dividing an input picture which is input in a manner corresponding to the observation position set by the observation position setting module, and output the first image and the second image as the picture to the display module; and
a polarizing filter which is provided between the observation position and members including the display module and the reflecting member, the polarizing filter transmitting light having the first circularly polarized light component.

2. The graphical display device of claim 1, wherein
the graphics processor is configured to generate the first image and the second image by changing positions of division of the images included in the picture in a manner corresponding to the observation position.

3. The graphical display device of claim 1, wherein
the graphics processor is configured to generate the first image and the second image by changing a ratio of division of the images included in the picture in a manner corresponding to the observation position.

4. The graphical display device of claim 2, wherein
the reflecting member comprises a first reflecting member and a second reflecting member, and
the first reflecting member and the second reflecting member are perpendicularly connected to both end portions of the display module respectively, are provided so as to face each other and are configured to display the picture displayed in the display module on reflecting surfaces which face each other.

5. The graphical display device of claim 4, wherein
each of the first reflecting member and the second reflecting member is a semi-silvered mirror which is transmissive and enables observation from a transmissive surface opposite to the reflecting surface.

6. The graphical display device of claim 4, wherein
each of the first reflecting member and the second reflecting member is a mirror.

7. The graphical display device of claim 4, wherein
one of the first reflecting member and the second reflecting member is formed by a mirror and the other one is formed by a semi-silvered mirror.

8. The graphical display device of claim 5, wherein
the polarizing filter is provided from the transmissive surface of the first reflecting member to the transmissive surface of the second reflecting member through a portion facing the display module.

9. The graphical display device of claim 5, wherein
the polarizing filter is provided in a lens portion of glasses and is provided in the observation position.

10. The graphical display device, wherein
the observation position setting module is configured to set the observation position in accordance with a main body menu or an external signal by an external device such as a remote controller.
